(19) United States
(12) Patent Application Publication
(10) Pub. No.: US 2022/0283875 A1
(43) Pub. Date: Sep. 8, 2022

(54) STORAGE SYSTEM, RESOURCE CONTROL METHOD, AND RECORDING MEDIUM

(71) Applicant: Hitachi, Ltd., Tokyo (JP)

(72) Inventor: Hitoshi UKAWA, Tokyo (JP)

(21) Appl. No.: 17/460,670

(22) Filed: Aug. 30, 2021

(30) Foreign Application Priority Data
Mar. 2, 2021 (JP) 2021-032991

(51) Int. Cl. G06F 9/50; G06F 9/455; G06F 16/182; H04L 29/08

(52) U.S. Cl. CPC G06F 9/5077; G06F 9/45558; G06F 16/183; H04L 67/1002; G06F 2009/4557; G06F 2009/45595

(57) ABSTRACT

Resources of physical servers are appropriately allocated. In a storage system including one or more physical servers, one or more protocol VMs to which resources of the physical servers are allocated and which perform processing related to a protocol of a file storage through a frontend network with a client and one or more filesystem VMs which perform processing related to management of a file in the file storage are formed in the physical server. The physical server acquires load information regarding loads of the protocol VMs and the filesystem VMs and controls the allocation of the resources of the physical servers to the protocol VMs and the filesystem VMs based on the load information.

### CROSS-REFERENCE TO RELATED APPLICATIONS

This application claims priority from Japanese Patent Application No. 2021-032991 filed Mar. 2, 2021. The entire content of the priority application is incorporated herein by reference.

### BACKGROUND

The present disclosure relates to a technology for controlling allocation of resources to virtual machines generated in physical server in a storage system including one or more physical servers.

For example, an HCI (Hyper-Converged Infrastructure) system is known that includes one or more physical servers realized by virtualizing infrastructure functions of storages or network devices. In the HCI system, virtual machines (VMs) performing various functions are generated in the physical servers. For example, in the physical server, a virtual machine (a hypervisor) that manages virtual machines, a virtual machine (a block storage VM) that supplies a function of a block storage to a storage device, and a virtual machine (a file storage VM) that supplies a function of a file stage are generated.

For example, U.S. Patent Application Publication No. 2018/0157522 discloses a technology for performing scale-up, scale-down, scale-in, and scale-out of a virtual file server based on a throughput or the like of the virtual file server.

### SUMMARY

According to the technology disclosed in U.S. Patent Application Publication No. 2018/0157522, when a load of a virtual file server increases, resources are controlled in units of virtual file servers.

For example, when virtual file servers are used by users in a company in which several thousand staff members work, simultaneous login arises at starting time work in the company in some cases. In these cases, mainly, loads are applied to only processing related to the login in the virtual file servers. On the other hand, in the technology disclosed in U.S. Patent Application Publication No. 2018/0157522, resources are allocated to a virtual file server. The allocated resources are not efficiently used for processing to which loads are applied, and thus there is concern of resource usage efficiency not being able to be improved.

The present disclosure has been devised in view of the foregoing circumstances and an objective of the present disclosure is to provide a technology for appropriately allocating resources of physical servers.

To achieve the foregoing objective, according to an aspect of the present invention, a storage system includes one or more physical servers. One or more first virtual machines to which resources of the physical servers are allocated and which perform processing related to a protocol of a file storage through a network with a client and one or more second virtual machines which perform processing related to management of a file in the file storage are formed in the physical server. The physical server acquires load information regarding loads of the first and second virtual machines and controls the allocation of the resources of the physical servers to the first and second virtual machines based on the load information.

### BRIEF DESCRIPTION OF THE DRAWINGS

FIG. 1 is a diagram illustrating an overall configuration of a computer system according to an embodiment;

FIG. 2 is a diagram illustrating an overall configuration of a storage system according to an embodiment;

FIG. 3 is a diagram illustrating a configuration of a physical server according to an embodiment;

FIG. 4 is an explanatory diagram illustrating a configuration of a filesystem VM management table according to an embodiment;

FIG. 5 is an explanatory diagram illustrating a configuration of a protocol VM management table according to an embodiment;

FIG. 6 is an explanatory diagram illustrating a configuration of a physical server management table according to an embodiment;

FIG. 7 is an explanatory diagram illustrating a configuration of a threshold management table according to an embodiment;

FIG. 8 is a flowchart illustrating load registration processing according to an embodiment;

FIG. 9 is a flowchart illustrating load balancing processing according to an embodiment; and

FIG. 10 is a flowchart illustrating resource control processing according to an embodiment.

### DETAILED DESCRIPTION OF THE EMBODIMENT

Embodiments will be described with reference to the drawings. The embodiments to be described below do not limit the invention of the claims, and all the elements described in the embodiments and all combinations of the elements are not necessarily essential to solutions of the present invention.

In the following description, information will be described with an expression of an “AAA table,” but the information may be expressed with any data structure. That is, to indicate that information does not depend on a data structure, an “AAA table” can be referred to as “AAA information.”

While a “program” is sometimes used as an operating entity when describing processing in the following description, since the program may be executed by a processor (for example, a CPU (Central Processing Unit)) to perform given processing appropriately while using a storage unit (for example, a memory) and/or an interface device or the like. Therefore, an operating entity for the processing may be considered as a processor (or an apparatus or a system including the processor). The processor may include a hardware circuit that performs some or all of the processing. The program may be installed from a program source to an apparatus such as a computer. The program source may be, for example, a recording medium (for example, a portable recording medium) which can be read by a program distribution server or computer. In the following description, two or more programs may be realized as one program or one program may be realized as two or more programs.

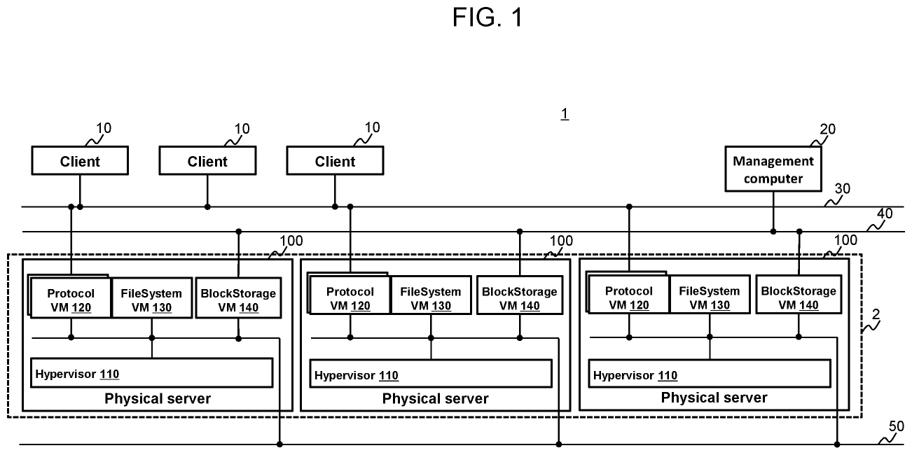

FIG. 1 is a diagram illustrating an overall configuration of a computer system according to an embodiment.

A computer system 1 includes one or more clients 10, a management computer 20, and a storage system 2. The storage system 2 includes one or more physical servers 100.

The client 10 performs various types of processing using data (for example, files) stored in the storage system 2. The management computer 20 performs processing of managing the storage system 2.

The physical server 100 includes, as a VM (virtual machine), a hypervisor 110, one or more protocol VMs (first virtual machine) 120, a filesystem VM (second virtual machine) 130, and a blockstorage VM 140.

One or more clients 10 and the protocol VMs 120 of the physical servers 100 are coupled via a frontend network 30. The frontend network 30 is, for example, a communication network such as a wired LAN (Local Area Network), a wireless LAN, or a WAN (Wide Area Network).

The management computer 20 and the blockstorage VM 140 of the physical server 100 are coupled via a management network 40. The management network 40 is, for example, a communication network such as a wired LAN, a wireless LAN, or a WAN.

Each of the VMs (110 to 140) of the physical servers 100 is coupled via an inter-node network 50. The inter-node network 50 is, for example, a communication network such as a wired LAN, a wireless LAN, or a WAN.

In the embodiment, the frontend network 30, the management network 40, and the inter-node network 50 are assumed to be different networks, but any of these plurality of networks may be identical networks, for example.

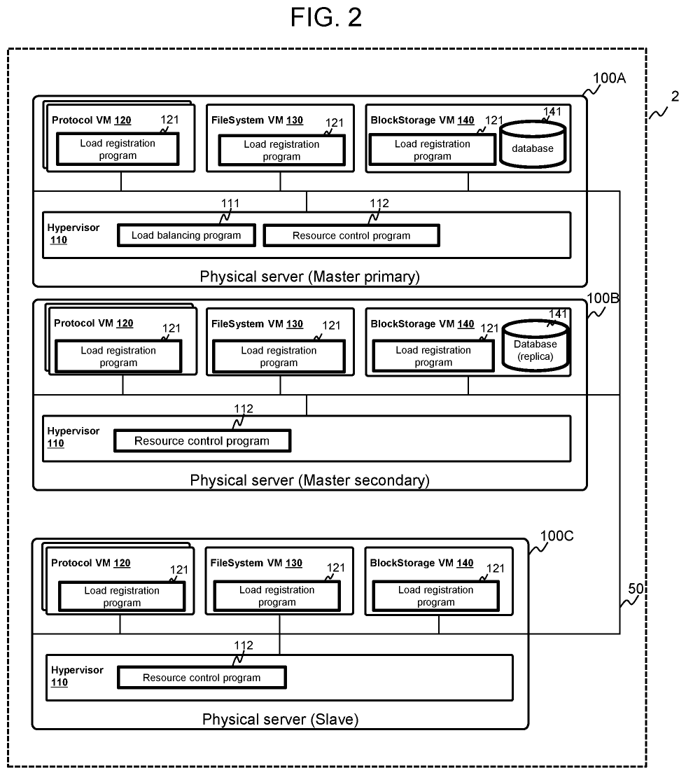

FIG. 2 is a diagram illustrating an overall configuration of a storage system according to an embodiment.

The storage system 2 includes the plurality of physical servers 100 that configure a cluster of a distributed file system. In the example of FIG. 2, the storage system 2 includes physical servers 100A, 100B, and 100C.

The physical server 100A is a physical server operating as a master primary (main master) that generally controls the physical servers configuring the cluster of the distributed file system. In the cluster of the distributed file system, for example, one physical server 100 operating as a master primary is provided.

The physical server 100A includes the hypervisor 110, one or more protocol VMs 120, the filesystem VM 130, and the blockstorage VM 140.

The hypervisor 110 generates or deletes a VM or controls allocation of resources to the VMs. The hypervisor 110 executes a load balancing program 111 and a resource control program 112. The load balancing program 111 is a program for performing processing of balancing loads in accordance with a difference in the number of connected clients 10 between the protocol VMs 120. The resource control program 112 is a program for performing processing of controlling allocation of resources to the protocol VMs 120 and the filesystem VM 130.

The protocol VM 120 performs some of the functions in the file storage, for example, functions in conformity with a protocol of a file system (for example, an NFS (Network File System) and/or a CIFS (Common Internet File System)) with the client 10 via the frontend network 30. As processing performed by the protocol VM 120, for example, there are some types of processing for user login, management of lock between users, user mapping between windows (registered trademark)/Linux (registered trademark), and the like. The protocol VM 120 performs a load registration program 121. The load registration program 121 is a program that acquires information regarding a load on an own-VM (here, the protocol VM 120) and performs processing of registering the information in a database 141 to be described below.

The filesystem VM 130 performs some functions (other than the functions of the protocol VM 120) in the file storage, for example, functions of managing files (conversion functions between a file I/O and a block I/0). The filesystem VM 130 performs the load registration program 121. The load registration program 121 is a program for performing processing of acquiring information regarding a load on a own-VM (here, the filesystem VM 130) and registering the information in the database 141 to be described below. The protocol VM 120 and the filesystem VM 130 provide functions necessary for the file storage.

The blockstorage VM 140 functions as a block storage that stores data in units of blocks in the storage device 154 to be described below and manages the data. The blockstorage VM 140 includes the database 141. The database 141 stores various kinds of information. The database 141 can be read and written by each physical server 100 of the storage system 2. In the embodiment, the database 141 stores a filesystem VM management table 161, a protocol VM management table 162, a physical server management table 163, and a threshold management table 164 to be described below. The blockstorage VM 140 executes the load registration program 121. The load registration program 121 is a program for performing processing of acquiring information regarding a load of an own-VM (here, the blockstorage VM 140) and registering the information in the database 141.

The physical server 100B is a physical server operating as a master secondary (sub-master) that can operate as a master primary when a failure occurs in the physical server 100A operating as the master primary in the distributed file system. In the cluster of the distributed file system, for example, two physical servers operating as the master secondary can be provided.

The physical server 100B includes the hypervisor 110, one or more protocol VMs 120, the filesystem VM 130, and the blockstorage VM 140. The hypervisor 110 of the physical server 100B executes the resource control program 112 and does not execute the load balancing program 111. When the physical server 100B operates as the master primary due to a failure of the physical server 100A, the load balancing program 111 is executed.

The database 141 of the blockstorage VM 140 of the physical server 100B is a replica of the database 141 of the blockstorage VM 140 of the physical server 100A. For example, data of the database 141 of the physical server 100A is copied at a predetermined timing by the blockstorage VM 140 of the physical server 100A.

The physical server 100C is a physical server other than the physical server operating as the master (the master primary and the master secondary) in the distributed file system. The physical server 100C includes the hypervisor 110, one or more protocol VMs 120, the filesystem VM 130, and the blockstorage VM 140. The blockstorage VM 140 of the physical server 100C may not include the database 141.

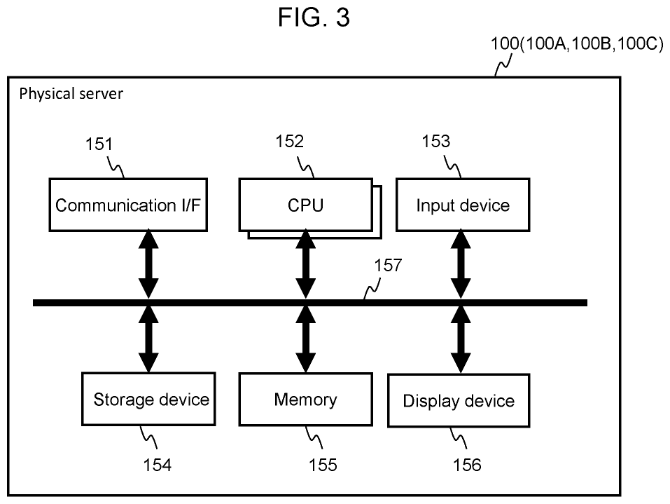

FIG. 3 is a diagram illustrating a configuration of a physical server according to an embodiment.

The physical server 100 (100A, 100B, and 100C) is configured by, for example, a PC (Personal Computer) or a general-purpose server. The physical server 100 includes resources such as a communication I/F 151, one or more CPUs (Central Processing Units) 152, an input device 153, a storage device 154, a memory 155, and a display device 156.

The communication I/F 151 is, for example, an interface such as a wired LAN card or a wireless LAN card and communicates with other apparatuses (for example, the clients 10, the management computer 20, and the other physical servers 100) via networks (30, 40, and 50).

The CPU 152 performs various types of processing in accordance with programs stored in the memory 155 and/or the storage device 154. In the embodiment, the CPU 152 is allocated to each VM. Units of allocation to each VM may be units of the number of CPUs 152.

The memory 155 is, for example, a RAM (RANDOM ACCESS MEMORY) and stores necessary information or programs which are executed by the CPU 152. In the embodiment, the memory 155 is allocated to each VM for usage.

The storage device 154 is, for example, a hard disk, a flash memory, or the like and stores a program executed by the CPU 152, data used in the CPU 152, files of user data used by the client 10, and the like. In the embodiment, the storage device 154 stores a program for realizing the hypervisor 110 (including, for example, the load balancing program 111 and the resource control program 112), a program for causing a VM generated by the hypervisor 110 to function as the protocol VM 120 (including, for example, the load registration program 121), a program for causing a VM generated by the hypervisor 110 to function as the filesystem VM 130 (including, for example, the load registration program 121), a program for causing a VM generated by the hypervisor 110 to function as the blockstorage VM 140, and the like. The storage device 154 stores data managed in the database 141 of the blockstorage VM 140.

The input device 153 is, for example, a mouse, a keyboard, or the like and receives information input by a user. The display device 156 is, for example, a display, and displays and outputs various kinds of information.

Next, various kinds of information stored in the database 141 of the blockstorage VM 140 of the physical server 100A will be described.

First, the filesystem VM management table 161 will be described.

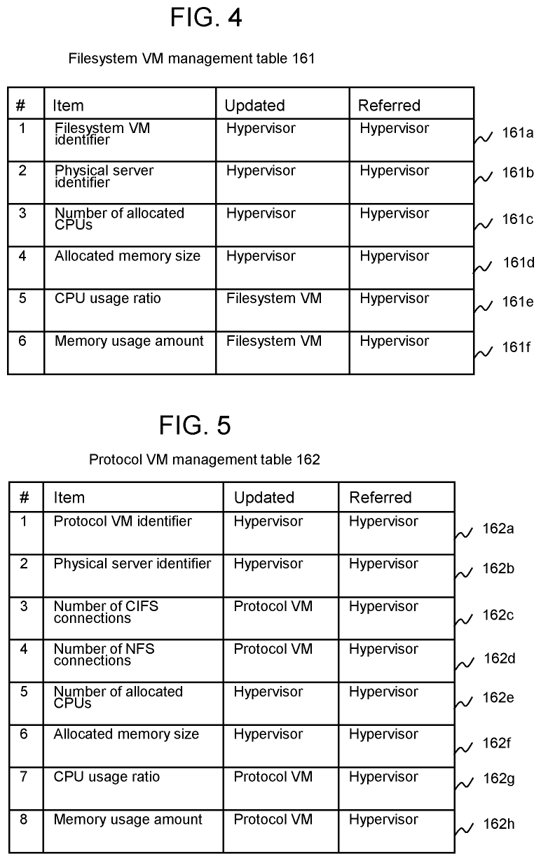

FIG. 4 is an explanatory diagram illustrating a configuration of the filesystem VM management table according to an embodiment.

The filesystem VM management table 161 is a table in which information regarding the filesystem VM 130 in the storage system 2 is managed and stores entries for each filesystem VM 130.

The entry of the filesystem VM management table 161 includes items of a filesystem VM identifier 161a, a physical server identifier 161b, the number of allocated CPUs 161c, an allocated memory size 161d, a CPU usage ratio 161e, and a memory usage amount 161f.

In the filesystem VM identifier 161a, an identifier with which the filesystem VM 130 corresponding to the entry can be uniquely identified (a filesystem VM identifier) is stored. In the physical server identifier 161b, an identifier with which the physical server 100 in which the filesystem VM 130 corresponding to the entry is generated is uniquely identified (a physical server identifier) is stored. In the number of allocated CPUs 161c, the number of CPUs 152 allocated to the filesystem VM 130 corresponding to the entry is stored. In the allocated memory size 161d, a size of the memory 155 allocated to the filesystem VM 130 corresponding to the entry is stored. In the CPU usage ratio 161e, a usage ratio of the CPU 152 allocated to the filesystem VM 130 corresponding to the entry is stored. In the memory usage amount 161f, a size which is used in the memory 155 allocated to the filesystem VM 130 corresponding to the entry (a memory usage amount) is stored.

In the filesystem VM management table 161, values of the filesystem VM identifier 161a, the physical server identifier 161b, the number of allocated CPUs 161c, and the allocated memory size 161d are updated and referred to by the hypervisor 110. Values of the CPU usage ratio 161e and the memory usage amount 161f are updated by the filesystem VM 130 and are referred to by the hypervisor 110.

Next, the protocol VM management table 162 will be described.

FIG. 5 is an explanatory diagram illustrating a configuration of a protocol VM management table according to an embodiment.

The protocol VM management table 162 is a table in which information regarding the protocol VM 120 in the storage system 2 is managed and stores entries for each protocol VM 120.

The entry of the protocol VM management table 162 includes items of a protocol VM identifier 162a, a physical server identifier 162b, the number of CIFS connections 162c, the number of NFS connections 162d, the number of allocated CPUs 162e, an allocated memory size 162f, a CPU usage ratio 162g, and a memory usage amount 162h.

In the protocol VM identifier 162a, an identifier with which the protocol VM 120 corresponding to the entry can be uniquely identified (a protocol VM identifier) is stored. In the physical server identifier 162b, an identifier with which the physical server 100 in which the protocol VM 120 corresponding to the entry is generated is uniquely identified (a physical server identifier) is stored. In the number of CIFS connections 162c, the number of clients connected by the CIFS to the protocol VM 120 corresponding to the entry is stored. In the number of NFS connections 162d, the number of clients connected by the NFS to the protocol VM 120 corresponding to the entry is stored. In the number of allocated CPUs 162e, the number of CPUs 152 allocated to the protocol VM 120 corresponding to the entry is stored. In the allocated memory size 162f, a size of the memory 155 allocated to the protocol VM 120 corresponding to the entry is stored. In the CPU usage ratio 162g, a usage ratio of the CPU 152 allocated to the protocol VM 120 corresponding to the entry is stored. In the memory usage amount 162h, a size which is used in the memory 155 allocated to the protocol VM 120 corresponding to the entry is stored.

In the protocol VM management table 162, values of the protocol VM identifier 162a, the physical server identifier 162b, the number of allocated CPUs 162e, and the allocated memory size 162f are updated and referred to by the hypervisor 110. Value of the number of CIFS connections 162c, the number of NFS connections 162d, the CPU usage ratio 162g, and the memory usage amount 162h are updated by the protocol VM 120 and are referred to by the hypervisor 110.

Next, the physical server management table 163 will be described.

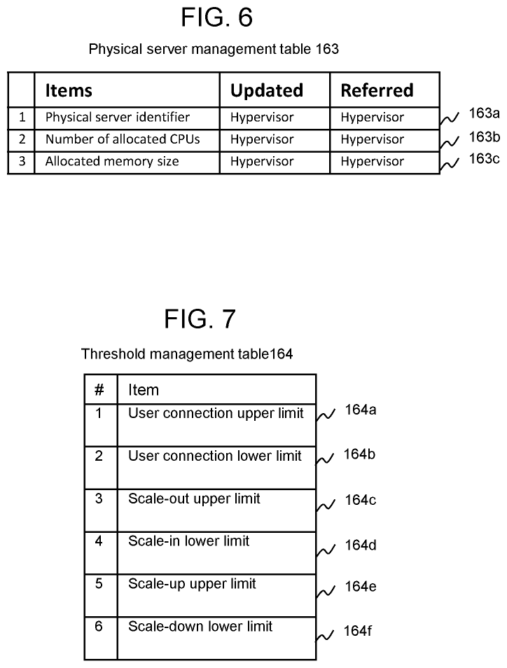

FIG. 6 is an explanatory diagram illustrating a configuration of a physical server management table according to an embodiment.

The physical server management table 163 is a table in which information regarding the physical server 100 in the storage system 2 is managed and stores entries for each physical server 100.

The entry of the physical server management table 163 includes items of a physical server identifier 163a, the number of allocated CPUs 163b, and an allocated memory size 163c.

In the physical server identifier 163a, an identifier with which the physical server 100 corresponding to the entry is uniquely identified (a physical server identifier) is stored. In the number of allocated CPUs 163b, the number of CPUs 152 which can be allocated in the physical server 100 corresponding to the entry is stored. In the allocated memory size 163c, a size of the allocable memory 155 in the physical server 100 corresponding to the entry is stored.

In the physical server management table 163, values of the physical server identifier 163a, the number of allocated CPUs 163b, and the allocated memory size 163c are updated and referred to by the hypervisor 110.

Next, the threshold management table 164 will be described.

FIG. 7 is an explanatory diagram illustrating a configuration of a threshold management table according to an embodiment.

The threshold management table 164 is a table in which thresholds used for processing are managed and includes items of a user connection upper limit 164a, a user connection lower limit 164b, a scale-out upper limit 164c, a scale-in lower limit 164d, a scale-up upper limit 164e, and a scale-down lower limit 164f.

In the user coupling upper limit 164a, an upper limit of the number of user connections for determining that a load of the protocol VM 120 is high (a user connection upper limit) in the load balancing program 111 is stored. In the user connection lower limit 164b, a lower limit of the number of user connections for determining that a load of the protocol VM 120 is low (a user connection lower limit) in the load balancing program 111 is stored. In the scale-out upper limit 164c, an upper limit for determining that a load of the protocol VM 120 is high (a scale-out upper limit) in the resource control program 112 is stored. When the load of the protocol VM 120 is higher than this upper limit, scale-out, that is, addition of a new protocol VM 120, is performed. In the scale-in lower limit 164d, a lower limit for determining that a load of the protocol VM 120 is low (a scale-in lower limit) in the resource control program 112 is stored. When the load of the protocol VM 120 is lower than this lower limit, scale-in, that is, deletion of the protocol VM 120, is performed.

In the scale-up upper limit 164e, an upper limit for determining that a load of the filesystem VM 130 is high (a scale-up upper limit) in the resource control program 112 is stored. When the load of the filesystem VM 130 is higher than this upper limit, scale-up, that is, addition of resources to the filesystem VM 130, is performed. In the scale-down lower limit 164f, a lower limit for determining that a load of the filesystem VM 130 is low (a scale-down lower limit) in the resource control program 112 is stored. When the load of the filesystem VM 130 is lower than this lower limit, scale-down, that is, releasing of resources from the filesystem VM 130, is performed.

Next, a processing operation in the storage system 2 will be described.

First, load registration processing will be described.

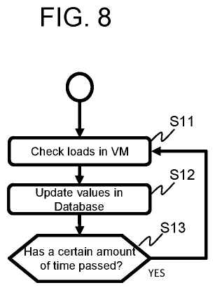

FIG. 8 is a flowchart illustrating the load registration processing according to an embodiment.

The load registration processing is performed by allowing the CPUs 152 allocated to the protocol VM 120, the filesystem VM 130, and the blockstorage VM 140 to execute the load registration program 121.

The load registration program 121 checks various loads in the VM executing the load registration program 121 (step S11). For example, the load registration program 121 executed by the protocol VM 120 checks the number of CIFS connections, the number of NFS connections, the CPU usage ratio, and the memory usage amount in the protocol VM 120. The load registration program 121 executed by the filesystem VM 130 checks the CPU usage ratio and the memory usage amount in the filesystem VM 130. The load registration program 121 executed by the blockstorage VM 140 checks the CPU usage ratio and the memory usage amount in the blockstorage VM 140.

Subsequently, the load registration program 121 updates the items corresponding to the corresponding table in the database 141 of the physical server 100 operating as the master primary based on the various checked loads (step S12). Subsequently, the load registration program 121 determines whether a certain amount of time has passed (step S13). When it is determined that the certain amount of time has passed (YES in step S13), the processing proceeds to step S11.

Through the load registration processing performed in the protocol VM 120, the filesystem VM 130, and the blockstorage VM 140, latest information regarding the loads of the VMs is stored in the database 141 of the physical server 100 operating as the master primary.

Next, load balancing processing will be described.

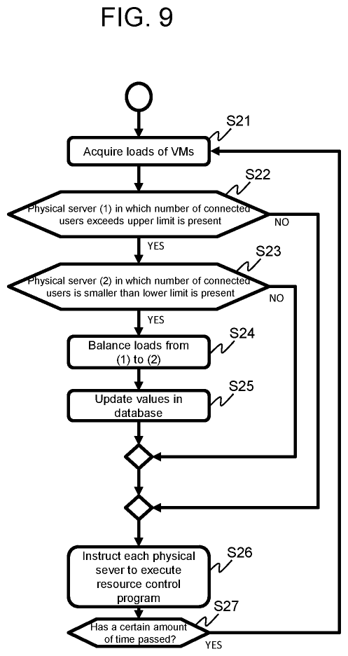

FIG. 9 is a flowchart illustrating the load balancing processing according to an embodiment.

The load balancing processing is performed by allowing the CPUs 152 allocated to the hypervisor 110 of the physical server 100 operating as the master primary to execute the load balancing program 111.

The load balancing program 111 acquires information regarding the loads of the VMs in the storage system 2 from the database 141 (step S21).

Subsequently, the load balancing program 111 determines whether there is the physical server in which the number of connected users (the number of CIFS connections +the number of NFS connections) exceeds the upper limit (the user connection upper limit of the user connection upper limit 164a of the threshold management table 164) (referred to as the physical server (1)) (step S22).

As a result, when there is the physical server in which the number of connections exceeds the user connection upper limit (YES in step S22), the load balancing program 111 causes the processing to proceed to step S23. Conversely, when there is no physical server in which the number of connections exceeds the user connection upper limit (NO in step S22), the processing proceeds to step S26.

In step S23, the load balancing program 111 determines whether there is the physical server in which the number of connected users is smaller than the lower limit (the user connection lower limit of the user connection lower limit 164b of the threshold management table 164) (referred to as the physical server (2)).

As a result, when there is the physical server in which the number of connections is smaller than the user connection lower limit (YES in step S23), the load balancing program 111 causes the processing to proceed to step S24. Conversely, when there is no physical server in which the number of connections is smaller than the user connection lower limit (NO in step S23), the processing proceeds to step S26.

In step S24, the load balancing program 111 balances the loads from the physical server (1) to the physical server (2). Specifically, the load balancing program 111 performs equivalent failover on some types of processing for the connected users from the protocol VM 120 of the physical server (1) to the protocol VM 120 of the physical server (2).

Subsequently, the load balancing program 111 updates the values of the corresponding table in the database 141 based on the result of the load balancing (step S25).

In step S26, the load balancing program 111 instructs the hypervisor 110 of each physical server 100 to execute the resource control program 112.

Subsequently, the load balancing program 111 determines whether a certain amount of time has passed (step S27). When it is determined that the certain amount of time has passed (YES in step S27), the processing proceeds to step S21.

Through the foregoing load balancing processing, the number of connected users can be balanced between the physical servers 100 and the loads of each physical server 100 can be balanced.

Next, resource control processing will be described.

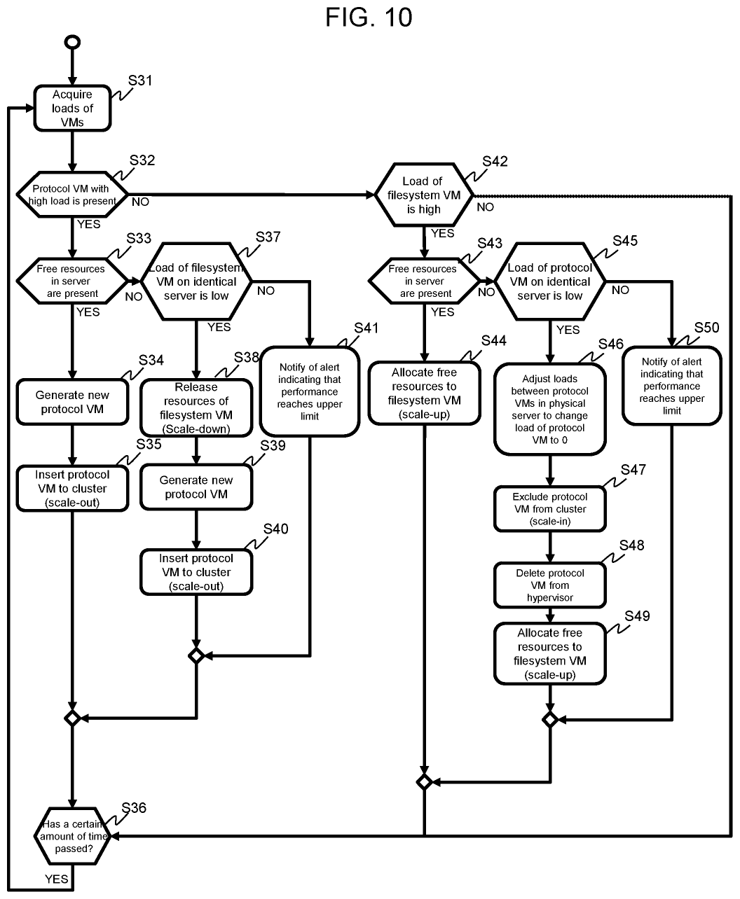

FIG. 10 is a flowchart illustrating the resource control processing according to an embodiment.

The resource control processing is performed by allowing the CPUs 152 allocated to the hypervisor 110 of each physical server 100 to execute the resource control program 112.

The resource control program 112 acquires information regarding the load of each VM in the physical server 100 in which there is the hypervisor 110 executing the resource control program 112 (in the description of this processing, referred to as an own-physical server) from the database 141 (step S31).

Subsequently, the resource control program 112 determines whether there is the protocol VM 120 with a high load in the physical server 100, that is, whether there is the protocol VM 120 with a load equal to or larger than a predetermined load (step S32). For example, the resource control program 112 may determine that there is the protocol VM 120 with the high load when there is the protocol VM 120 satisfying any of a case in which the memory usage amount exceeds a predetermined threshold, a case in which the CPU usage ratio exceeds a predetermined threshold, and a case in which a sum of the numbers of connections (the number of CIFS connections +the number of NFS connections) exceeds a predetermined threshold.

As a result, when it is determined that there is the protocol VM 120 with the high load (YES in step S32), the resource control program 112 causes the processing to proceed to step S33. Conversely, when it is determined that there is no protocol VM 120 with the high load (NO in step S32), the processing proceeds to step S42.

In step S33, the resource control program 112 determines whether there are free resources in the own-physical server. Here, whether there are the free resources can be specified in accordance with, for example, whether the number of allocated CPUs and the allocated memory size in the entry corresponding to the own-physical server of the physical server management table 163 are different from the number of allocated CPUs and the allocated memory size in all the VMs of the own-physical server.

As a result, when it is determined that there are the free resources in the own-physical server (YES in step S33), the resource control program 112 generates a new protocol VM 120 to which the free resources of the own-physical server are allocated (step S34) and scales out the distributed file system by inserting the generated protocol VM 120 to the cluster of the distributed file system in the storage system 2 (step S35). Thus, it is possible to improve efficiency of the processing performed by the protocol VM 120. Subsequently, the resource control program 112 causes the processing to proceed to step S36.

In step S36, the resource control program 112 determines whether a certain amount of time has passed. When it is determined that the certain amount of time has passed (YES in step S36), the processing proceeds to step S31.

Conversely, when it is determined that there are no free resources in the own-physical server (NO in step S33), the resource control program 112 determines whether the load of the filesystem VM 130 on the own-physical server is low (step S37). For example, when the memory usage amount of the filesystem VM 130 is equal to or smaller than a predetermined threshold and the CPU usage ratio is equal to or smaller than a predetermined threshold, the resource control program 112 may determine that the load of the filesystem VM 130 is low.

As a result, when it is determined that the load of the filesystem VM 130 on the own-physical server is low (YES in step S37), the resource control program 112 releases (scales down) some of the resources allocated to the filesystem VM 130 (step S38), generates a new protocol VM 120 to which the released resources are allocated (step S39), and scales out the distributed file system by inserting the generated protocol VM 120 to the cluster of the distributed file system in the storage system 2 (step S40). Thus, it is possible to improve efficiency of the processing performed by the protocol VM 120. Subsequently, the resource controlling program 112 causes the processing to proceed to step S36. The processing proceeds to step S36.

Conversely, when it is determined that the load of the filesystem VM 130 on the own-physical server is not low (NO in step S37), the resource control program 112 notifies of an alert indicating that performance of the own-physical server reaches an upper limit (for example, notifies the management computer 20) (step S41). Then, the processing proceeds to step S36.

In step S42, the resource control program 112 determines whether the load of the filesystem VM 130 on the own-physical server is high, that is, whether the load of the filesystem VM 130 is equal to or larger than a predetermined load. For example, when the memory usage amount of the filesystem VM 130 exceeds a predetermined threshold or when the CPU usage ratio exceeds a predetermined threshold, the resource control program 112 may determine that the load of the filesystem VM 130 is high.

As a result, when it is determined that the load of the filesystem VM 130 is high (YES in step S42), the resource control program 112 causes the processing to proceed to step S43. Conversely, when it is determined that the load of the filesystem VM 130 is not high (NO in step S42), the processing proceeds to step S36.

In step S43, the resource control program 112 determines whether there are free resources in the own-physical server. Here, whether there are the free resources can be specified in accordance with, for example, whether the number of allocated CPUs and the allocated memory size in the entry corresponding to the own-physical server of the physical server management table 163 are different from the number of allocated CPUs and the allocated memory size in all the VMs which are in the own-physical server.

As a result, when it is determined that there are the free resources in the own-physical server (YES in step S43), the resource control program 112 scales up the distributed file system by allocating the free resources of the own-physical server to filesystem VM 130 (step S44). Thus, it is possible to improve efficiency of the processing performed by the filesystem VM 130. Subsequently, the resource control program 112 causes the processing to proceed to step S36.

Conversely, when it is determined that there are no free resources in the own-physical server (NO in step S43), the resource control program 112 determines whether the load of the protocol VM 120 on the own-physical server is low (step S45). For example, when the memory usage amount of the protocol VM 120 is equal to or smaller than the predetermined threshold, the CPU usage ratio is equal to or smaller than the predetermined threshold, and the sum of the numbers of connected users (the number of CIFS connections+the number of NFS connections) is equal to or smaller than the predetermined threshold, the resource control program 112 may determine that the load of the protocol VM 120 is low.

As a result, when it is determined that the load of the protocol VM 120 on the own-physical server is low (YES in step S45), the resource control program 112 adjusts the loads between the protocol VMs 120 in the own-physical server to change the load of at least any one protocol VM 120 to 0 (step S46) and excludes (scales out) the protocol VM 120 in which the load is changed to 0 from the cluster of the distributed file system (step S47). Subsequently, the resource control program 112 deletes the protocol VM 120 excluded from the cluster from the VMs managed by the hypervisor 110 (step S48). Thus, the resources allocated to the protocol VM 120 are released. Subsequently, the resource control program 112 scales up the distributed file system by allocating the released resources to the filesystem VM 130 (step S49). Thus, it is possible to improve efficiency of the processing performed by the filesystem VM 130. Subsequently, the resource control program 112 causes the processing to proceed to step S36.

Conversely, when it is determined that the load of the protocol VM 120 on the own-physical server is not low (NO in step S45), the resource control program 112 notifies of an alert indicating that the performance of the own-physical server reaches the upper limit (for example, notifies the management computer 20) (step S50). The processing proceeds to step S36.

The present invention is not limited to the above-described embodiments and can be appropriately modified within the scope of the present invention without departing from the gist of the present invention.

For example, in the foregoing embodiment, not to generate the loads arising due to transfer of various kinds of data for managing files associated with an increase or a decrease of the filesystem VM 130, control is not performed to adjust the number of filesystem VMs 130. However, the present invention is not limited thereto. A resource amount allocated to the filesystem VMs 130 in the physical server 100 may be adjusted by adjusting the number of filesystem VMs 130.

In the foregoing embodiment, the resources are allocated using the number of CPUs 152 as units, but the present invention is not limited thereto. For example, the resources may be allocated in units of CPU cores of the CPU 152 or the resources may be allocated in units of processing times of the CPUs 152 or the CPU cores.

In the forgoing embodiments, some or all of the processing performed by the CPU may be performed by a hardware circuit. The program according to the foregoing embodiments may be installed from a program source. The program source may be a program distribution server or a storage medium (for example, a portable storage medium).

What is claimed is:

1. A storage system comprising:
one or more physical servers; wherein
one or more first virtual machines to which resources of the physical servers are allocated and which perform processing related to a protocol of a file storage through a network with a client and one or more second virtual machines which perform processing related to management of a file in the file storage are formed in the physical server, and
the physical server acquires load information regarding loads of the first and second virtual machines and controls the allocation of the resources of the physical servers to the first and second virtual machines based on the load information.

2. The storage system according to claim 1, wherein the physical server controls an allocation amount of the resources of the physical servers to the first or second virtual machine based on the load information.

3. The storage system according to claim 1, wherein the physical server controls the allocation of the resources of the physical servers by controlling at least one of the number of first virtual machines or the number of second virtual machines based on the load information.

4. The storage system according to claim 3, wherein the physical server generates a new first virtual machine when a load of the first virtual machine is equal to or larger than a predetermined load and there are free resources in the physical server.

5. The storage system according to claim 4, wherein, when the load of the first virtual machine is equal to or larger than the predetermined load and there are no free resources in the physical server, the physical server releases some of the resources allocated to the second virtual machines of which the load is lower than the predetermined load and generates the new first virtual machine using the released resources.

6. The storage system according to claim 2, wherein, when the load of the second virtual machine is equal to or larger than a predetermined load and there are free resources in the physical server, the physical server additionally allocates free resources of the physical server to the second virtual machine.

7. The storage system according to claim 6, wherein
a plurality of the first virtual machines are generated in the physical server, and
when the load of the second virtual machine is equal to or larger than the predetermined load and there are no free resources in the physical server, the physical server deletes some of the plurality of first virtual machines and allocates the resources allocated to the deleted first virtual machines to the second virtual machine.

8. The storage system according to claim 1, wherein
the storage system includes a plurality of the physical servers, and
at least one of the physical servers performs processing of transferring some of clients connected to the other physical servers to the physical server in which the number of connected clients is equal to or smaller than a predetermined number.

9. A resource control method by a storage system including one or more physical servers, the method comprising:
one or more first virtual machines to which resources of the physical servers are allocated and which perform processing related to a protocol of a file storage through a network with a client and one or more second virtual machines which perform processing related to management of a file in the file storage are formed in the physical server, and
the physical server acquires load information regarding loads of the first and second virtual machines and controls the allocation of the resources of the physical servers to the first and second virtual machines based on the load information.

10. A non-transitory computer-readable recording medium that records a resource control program executed by a physical server included in a storage system, wherein
one or more first virtual machines to which resources of the physical servers are allocated and which perform processing related to a protocol of a file storage through a network with a client and one or more second virtual machines which perform processing related to management of a file in the file storage are formed in the physical server, and
the resource control program causes the physical server to acquire load information regarding loads of the first and second virtual machines and control the allocation of the resources of the physical servers to the first and second virtual machines based on the load information.
